(19) United States
(12) Patent Application Publication
(10) Pub. No.: US 2012/0261909 A1
(43) Pub. Date: Oct. 18, 2012

(54) Expandable trailer

(76) Inventor: Jean-Yves Belanger, (US)

(21) Appl. No.: 13/066,275

(22) Filed: Apr. 12, 2011

(51) Int. Cl. B62D 63/08

(52) U.S. Cl. 280/656

(57) ABSTRACT

A trailer of the type which can be extended or retracted when required.

### BACKGROUND OF THE INVENTION

1. Field of the Invention

This invention relates to trailers and more particularly relates to expandable trailers. 2. Description of the Related Art

Many different types and sizes of trailers are currently available in the market to accommodate various sizes of loads.

A search of prior art records has unveiled the following patents:
CA 1,229,356 issued in 1987 to MacDonald.
CA 2,387,472 registered in 2002 to Bordeleau.
CA 2,523,874 registered in 2005 to Boon.
CA 2,533,682 issued in 2008 to Di Franco.
CA 2,683,129 registered in 2008 to Serre.
CA 2,026,320 registered in 1990 to Delacollette.
CA 2,540,455 registered in 2006 to Wilhelm.
CA 2,197,025 issued in 2000 to Grenier.
CA 2,366,881 issued in 2008 to Mensch.
CA 2,323,912 issued in 2008 to Jager.
U.S. Pat. No. 4,772,038 issued in 1988 to MacDonald.
US 2004/0061313 registered in 2002 to Courtney.
U.S. Pat. No. 5,560,444 issued in 1996 to Tiedge.
U.S. Pat. No. 6,003,919 issued in 1999 to Shook.
U.S. Pat. No. 5,118,245 issued in 1992 to Dunkel.
U.S. Pat. No. 3,556,545 issued in 1971 to VanRaden.
U.S. Pat. No. 7,810,834 issued in 2010 to Schneider et al.
U.S. Pat. No. 6,746,040 issued in 2004 to Bordeleau et al.
U.S. Pat. No. 6,739,617 issued in 2004 to Martin.
U.S. Pat. No. 6,511,092 issued in 2003 to Chepa.
U.S. Pat. No. 7,712,813 issued in 2010 to Di Franco.
US 2009/0295192 registered in 2009 to Hyde.

### SUMMARY OF THE INVENTION

It is an object of the invention to provide a trailer whose width can be modified if needed, that is not costly and is easy to adjust.

The present invention concerns an expandable trailer comprising a framework mounted on wheels, a floor mounted on the framework, a front panel having sliding extensions, side panels hinged to the floor, a winch assembly for attaching a vehicle on the loading floor, a support leg, and a towing hitch for attaching the trailer to a vehicle.

The sliding extensions are engaged into slide rails coupled to the front panel to be easily translated between a retracted position and an extended position. The side panels can be used in raised or lowered position. A hand extension mechanism enables to manually extend the side panels of the trailer to increase the width of the loading floor space inside.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention.

Accordingly, the drawings and description are to be regarded as illustrative in nature, and not as restrictive.

### BRIEF DESCRIPTION OF THE DRAWINGS

The accompanying drawings show illustrative embodiment of the present invention from which the features and advantages will be readily apparent.

FIG. 1 is a side perspective view of a trailer incorporating the principles of the invention.

FIG. 2 is a side perspective view illustrating an extension mechanism enabling the trailer of FIG. 1 to be in extended position in accordance with the present invention.

FIG. 3 is a side perspective view illustrating the side panels of the trailer in extended position in accordance with the present invention.

FIG. 4 is a front perspective view illustrating the sliding extensions enabling the front panel of the trailer to be in extended position in accordance with the present invention.

FIG. 5 is a side perspective view illustrating the trailer of FIG. 1 in raised position in accordance with the present invention.

FIG. 6 is a rear perspective view illustrating the sliding extensions enabling the front panel of the trailer to be in extended position in accordance with the present invention.

### DETAILED DESCRIPTION OF THE INVENTION

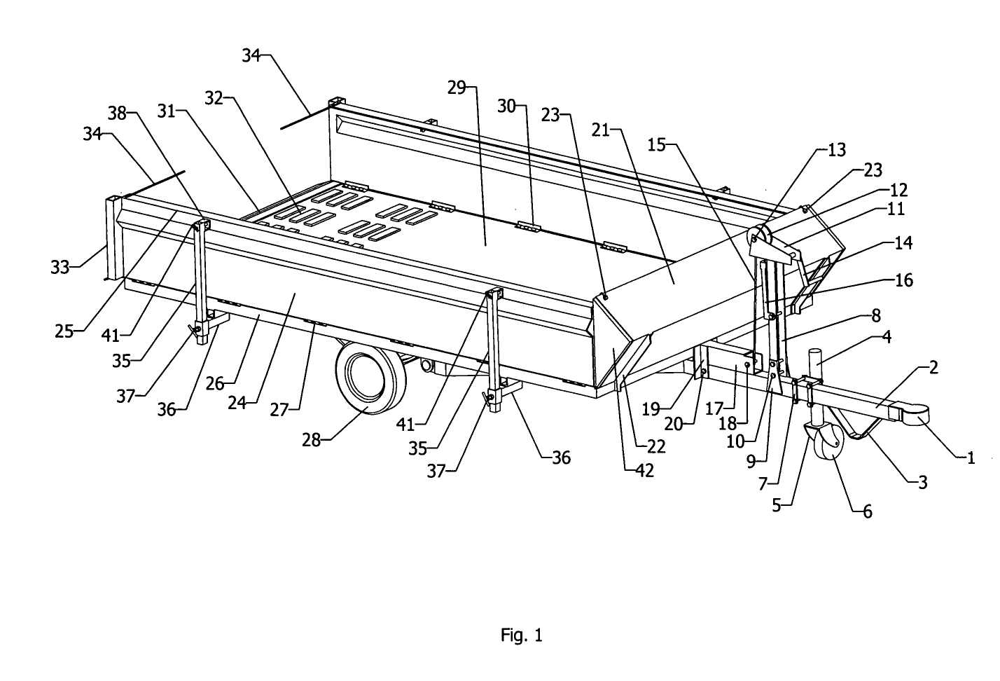

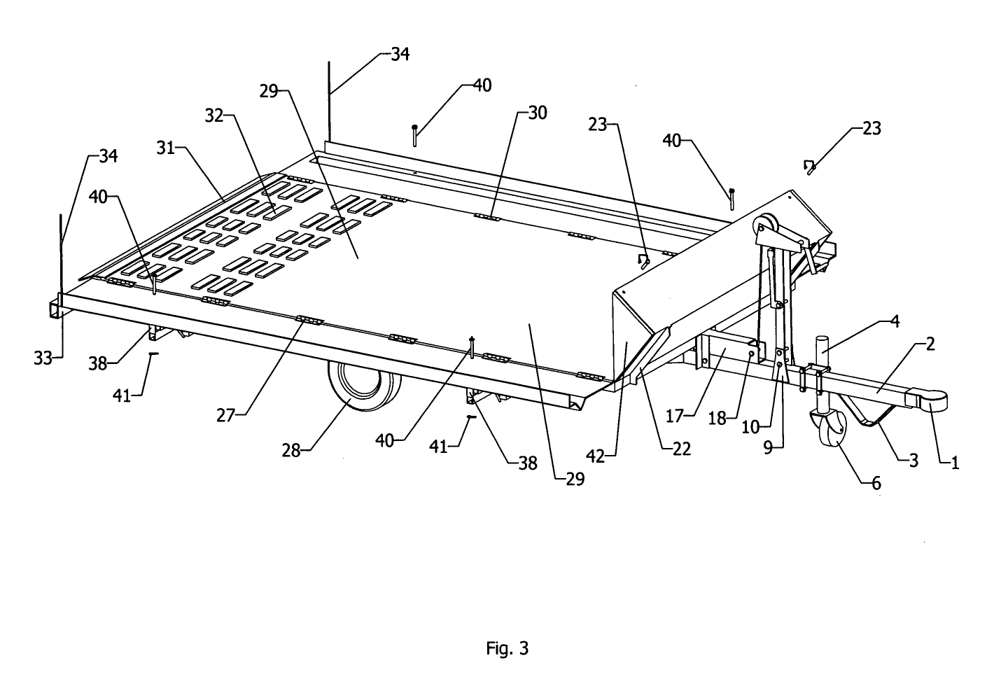

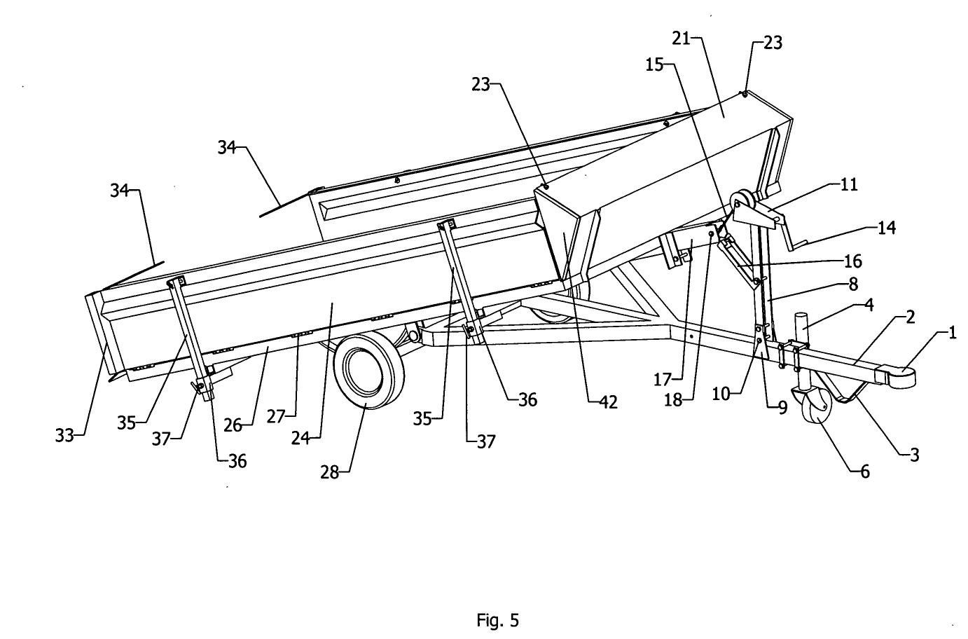

Referring now to the drawings, more particularly to FIGS. 1 to 6, it will be seen that a trailer according to the invention consists of a framework (26) that is mounted on wheels (28), and a floor (29) mounted on the framework (26). Side panels (24) are hinged to the floor (29). The side panels (24) of the trailer can be used in raised or lowered position.

Furthermore, a hand extension mechanism enables to manually extend the side panels (24) of the trailer to increase the width of the loading floor space inside.

To draw the trailer, there is provided a towing hitch (1) for attaching the trailer to a vehicle as is known in the art. Furthermore, it is shown a support leg (4) and a winch assembly for attaching a vehicle on the loading floor (29) as is known in the art.

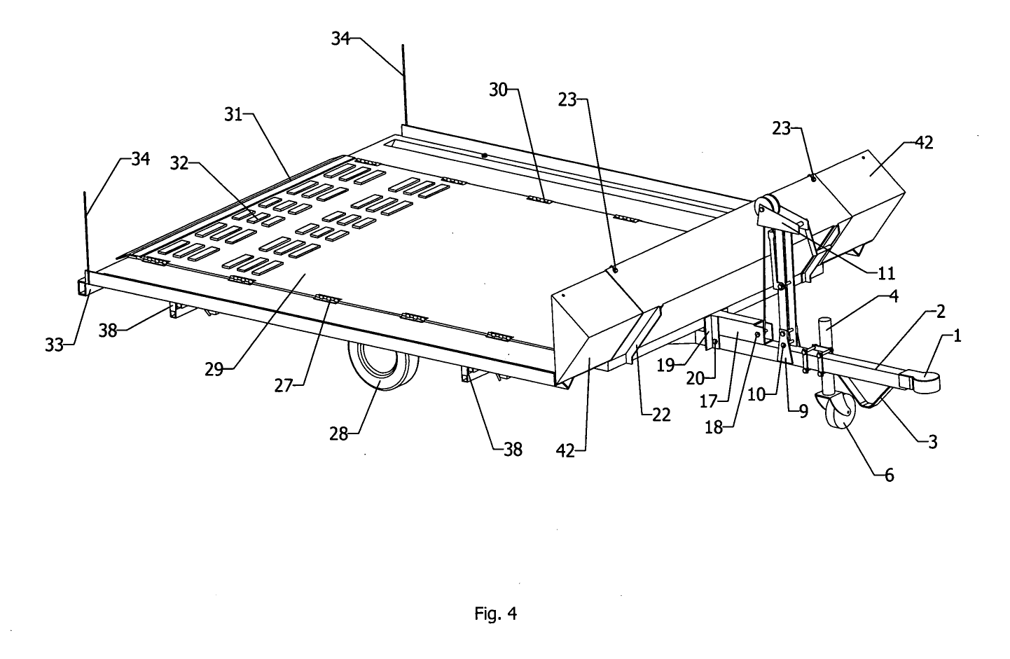

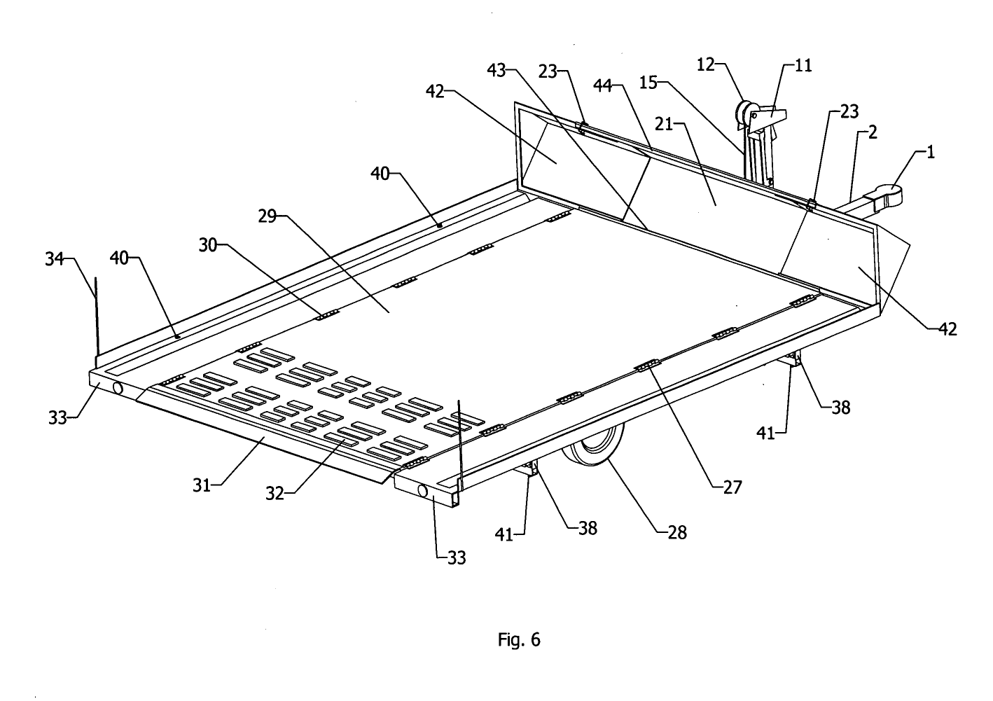

More specifically to FIGS. 4 and 6, the trailer comprises a front panel (21) having sliding extensions (42) that are engaged into slide rails (43)(44) coupled to the front panel (21) to be easily translated between a retracted position and an extended position. Furthermore, each sliding extension (42) is secured to the front panel (21) thereby an interlock pin (23).

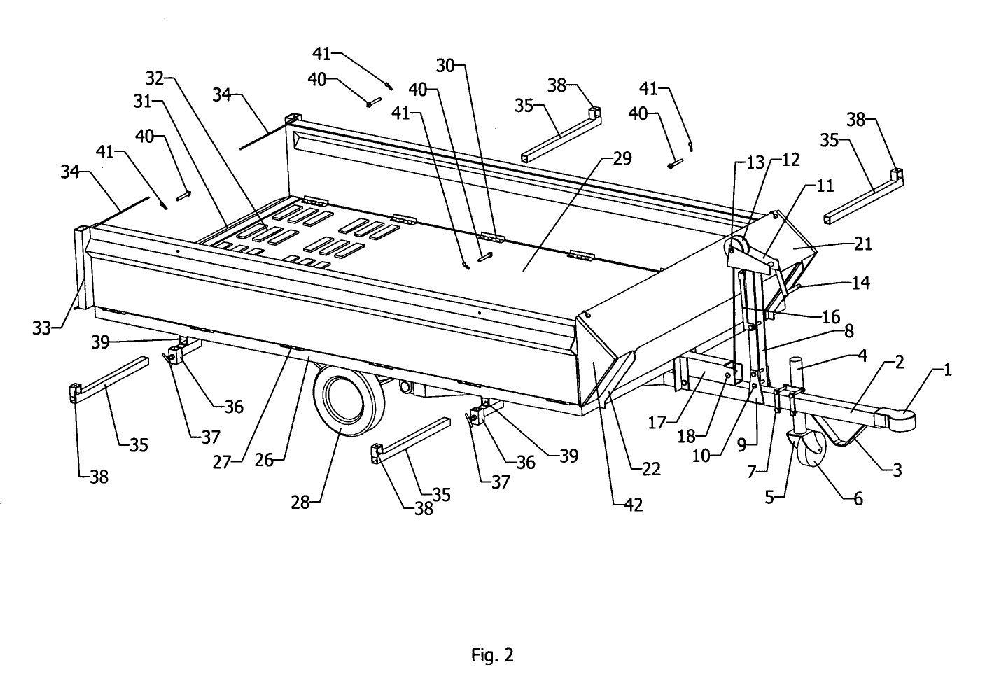

FIG. 2, illustrates the extension mechanism that is comprised of a plurality of tube members (35) configured to be coupled to the upper portion (25) of the side panels (24) and beneath the framework (26). When the trailer is in extended position each tube member (35) is disposed horizontally and coupled to a tube section (39) that is welded beneath the framework (26) to allow the extension of the side panels (24), which each tube member (35) is configured for defining a hole (38) to integrate therein a pin (40) that is aligned with a hole positioned through the upper portion (25) of the side panels (24) and to be secured thereby a securing attachment (41).

FIGS. 1-5, illustrate the trailer in retracted position. When the trailer is in retracted position the side panels (24) are raised and each tube member (35) is coupled vertically to the upper portion (25) of the side panels (24) to be integrated into a tube section (36) that is welded to the tube section (39) disposed beneath the framework (26) and to be secured thereby a screwing pin (37).

Although only a single embodiment of the present invention has been described and illustrated, the present invention is not limited to the features of this embodiment, but includes all variations and modifications within the scope of claims.

The embodiments of the invention for which an exclusive property or privilege is claimed, are defined as follows:

I claim:

1. An expandable trailer comprising:
a framework mounted on wheels;
a floor mounted on the framework;
a front panel having sliding extensions engaged into slide rails coupled to the front panel to be easily translated between a retracted or extended position, and which each sliding extension is secured to the front panel by an interlock pin;
side panels hinged to the framework; and
a hand extension mechanism enabling to manually extend the side panels to increase the width of the loading floor space inside.

2. The trailer defined in claim 1, wherein the extension mechanism comprises a plurality of tube members configured to be coupled to the upper portion of the side panels and beneath the framework, and when the trailer is in extended position each tube member is disposed horizontally and coupled to a tube section that is welded beneath the framework to allow the extension of the side panels, and which each tube member is configured for defining a hole to integrate therein a pin that is aligned with a hole positioned through the upper portion of the side panels and to be secured thereby a securing attachment.

3. The trailer defined in claim 1, wherein the side panels are raised when the trailer is in retracted position such that each tube member is coupled vertically to the upper portion of the side panels and to be integrated into a tube section that is welded to said tube section disposed beneath the framework and to be secured thereby a screwing pin.
